(19) United States
(12) Patent Application Publication
(10) Pub. No.: US 2005/0091684 A1
(43) Pub. Date: Apr. 28, 2005

(54) Robot apparatus for supporting user's actions

(76) Inventors: Shunichi Kawabata, Ome-shi (JP); Masafumi Tamura, Chofu-shi (JP); Tomotaka Miyazaki, Kawasaki-shi (JP); Takashi Yoshimi, Fujisawa-shi (JP); Junko Hirokawa, Tokyo (JP); Hideki Ogawa, Yokosuka-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/946,129

(22) Filed: Sep. 22, 2004

(30) Foreign Application Priority Data
Sep. 29, 2003 (JP) 2003-337758

(51) Int. Cl. H04N 5/445; G06F 3/00; H04N 7/025

(52) U.S. Cl. 725/35; 725/46; 725/34

(57) ABSTRACT

A robot apparatus includes a memory unit that stores schedule information indicative of a user identifier for designating one of a plurality of users, an action that is to be done by the user designated by the user identifier, and a start condition for the action, a determination unit that determines whether a condition designated by the start condition is established, and a support process execution unit that executes, when the condition designated by the start condition is established, a support process, based on the schedule information, for supporting the user's action corresponding to the established start condition with respect to the user designated by the user identifier corresponding to the established start condition.

### CROSS-REFERENCE TO RELATED APPLICATIONS

This application is based upon and claims the benefit of priority from prior Japanese Patent Application No. 2003-337758, filed Sep. 29, 2003, the entire contents of which are incorporated herein by reference.

### BACKGROUND OF THE INVENTION

1. Field of the Invention

The present invention relates to a robot apparatus for supporting user's actions.

2. Description of the Related Art

In recent years, a variety of information terminal apparatuses, such as PDAs (Personal Digital Assistants) and mobile phones, have been developed. Most of them have a schedule management function that edits and displays schedule data. Also developed is an information terminal apparatus having an alarm function that produces alarm sound at a prescheduled data/time in cooperation with schedule data.

Jpn. Pat. Appln. KOKAI Publication No. 11-331368 discloses an information terminal apparatus that can selectively use a plurality of alarm functions using, e.g. sound, vibration and LED (Light Emitting Diode) light.

The schedule management function and alarm function of the prior-art information terminal apparatus, however, are designed on assumption that one user possesses one information terminal apparatus. It is thus difficult, for example, for all family members to use the terminal as a schedule management tool for all the family members.

In addition, the schedule management function and alarm function in the prior art execute schedule management on the basis of time alone. These functions are thus not suitable for schedule management in the home.

It is difficult to simply manage the schedule in the home on the basis of time alone, unlike the schedule in offices and schools. In offices, there are many items, such as the time of a conference, the time of a meeting and a break time, which can definitely be scheduled based on time. In the home, however, schedules are often varied on the basis of life patterns. For instance, the time of taking drugs varies depending on the time of having a meal, and the timing of taking the washing in varies depending on the weather or the time of the end of washing. The schedules in the home cannot simply be managed on the basis of time alone. It is insufficient, therefore, to merely indicate the registered time, as in the prior-art information terminal apparatus.

### BRIEF SUMMARY OF THE INVENTION

According to an embodiment of the present invention, there is provided a robot apparatus comprising: a memory unit that stores schedule information indicative of a user identifier for designating one of a plurality of users, an action that is to be done by the user designated by the user identifier, and a start condition for the action; a determination unit that determines whether a condition designated by the start condition is established; and a support process execution unit that executes, when the condition designated by the start condition is established, a support process, based on the schedule information, for supporting the user's action corresponding to the established start condition with respect to the user designated by the user identifier corresponding to the established start condition.

According to another embodiment of the present invention, there is provided a robot apparatus comprising: a body having an auto-movement mechanism; a sensor that is provided on the body and senses a surrounding condition; a memory unit that stores schedule information indicative of a user identifier for designating one of a plurality of users, an action that is to be done by the user designated by the user identifier, and an event that is a start condition for the action; a monitor unit that executes a monitor operation for detecting occurrence of the event, using the auto-movement mechanism and the sensor; and a support process execution unit that executes, when the occurrence of the event is detected by the monitor unit, a support process, based on the schedule information, for supporting the user's action corresponding to the event whose occurrence is detected, with respect to the user designated by the user identifier corresponding to the event whose occurrence is detected.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the external appearance of a robot apparatus according to an embodiment of the present invention;

FIG. 2 is a block diagram showing the system configuration of the robot apparatus shown in FIG. 1;

FIG. 3 is a view for explaining an example of a path of movement at a time the robot apparatus shown in FIG. 1 executes a patrol-monitoring operation;

FIG. 4 is a view for explaining an example of map information that is used in an auto-movement operation of the robot apparatus shown in FIG. 1;

FIG. 5 shows an example of authentication information that is used in an authentication process, which is executed by the robot apparatus shown in FIG. 1;

FIG. 6 shows an example of schedule management information that is used in a schedule management process, which is executed by the robot apparatus shown in FIG. 1;

FIG. 7 is a flow chart illustrating an example of the procedure of a schedule registration process, which is executed by the robot apparatus shown in FIG. 1;

FIG. 8 is a flow chart illustrating an example of the procedure of a schedule management process, which is executed by the robot apparatus shown in FIG. 1;

FIG. 9 is a flow chart illustrating an example of the procedure of a support process, which is executed by the robot apparatus shown in FIG. 1;

FIG. 10 shows a state in which the robot apparatus shown in FIG. 1 executes a support process for one of a plurality of users; and

FIG. 11 is a flow chart illustrating a specific example of a schedule management process that is executed by the robot apparatus shown in FIG. 1.

### DETAILED DESCRIPTION OF THE INVENTION

An embodiment of the present invention will now be described with reference to the accompanying drawings.

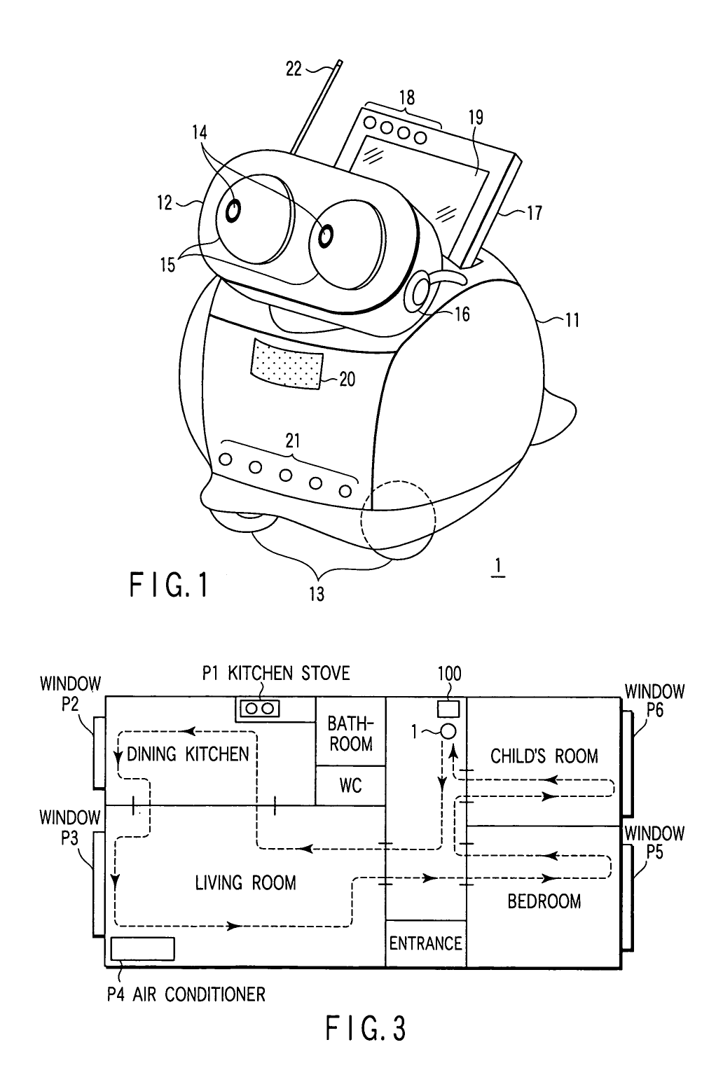

FIG. 1 shows the external appearance of a schedule management apparatus according to the embodiment of the invention. The schedule management apparatus executes a schedule management operation for supporting actions of a plurality of users (family members) in the home. The schedule management apparatus has an auto-movement mechanism and is realized as a robot apparatus 1 having a function for determining its own actions in order to support the users.

The robot apparatus 1 includes a substantially spherical robot body 11 and a head unit 12 that is attached to a top portion of the robot body 11. The head unit 12 is provided with two camera units 14. Each camera unit 14 is a device functioning as a visual sensor. For example, the camera unit 14 comprises a CCD (Charge-Coupled Device) camera with a zoom function. Each camera unit 14 is attached to the head unit 12 via a spherical support member 15 such that a lens unit serving as a visual point is freely movable in vertical and horizontal directions. The camera units 14 take in images such as images of the faces of persons and images of the surroundings. The robot apparatus 1 has an authentication function for identifying a person by using the image of the face of the person, which is imaged by the camera units 14.

The head unit 12 further includes a microphone 16 and an antenna 22. The microphone 16 is a voice input device and functions as an audio sensor for sensing the user's voice and the sound of surroundings. The antenna 22 is used to execute wireless communication with an external device.

The bottom of the robot body 11 is provided with two wheels 13 that are freely rotatable. The wheels 13 constitute a movement mechanism for moving the robot body 11. Using the movement mechanism, the robot apparatus 1 can autonomously move within the house.

A display unit 17 is mounted on the back of the robot body 11. Operation buttons 18 and an LCD (Liquid Crystal Display) 19 are mounted on the top surface of the display unit 17. The operation buttons 18 are input devices for inputting various data to the robot body 11. The operation buttons 18 are used to input, for example, data for designating the operation mode of the robot apparatus 11 and a user's schedule data. The LCD 19 is a display device for presenting various information to the user. The LCD 19 is realized, for instance, as a touch screen device that can recognize a position that is designated by a stylus (pen) or the finger.

The front part of the robot body 11 is provided with a speaker 20 functioning as a voice output device, and sensors 21. The sensors 21 include a plurality of kinds of sensors for monitoring the conditions of the inside and outside of the home, for instance, a temperature sensor, an odor sensor, a smoke sensor, and a door/window open/close sensor. Further, the sensors 21 include an obstacle sensor for assisting the auto-movement operation of the robot apparatus 1. The obstacle sensor comprises, for instance, a sonar sensor.

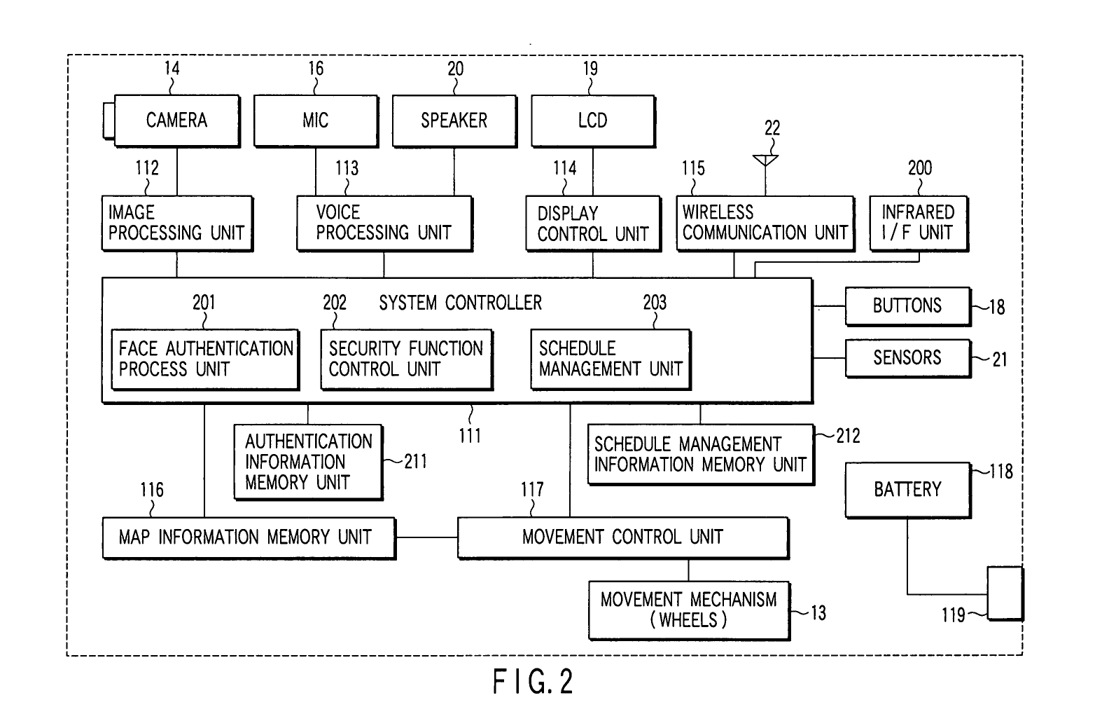

Next, the system configuration of the robot apparatus 1 is described referring to FIG. 2.

The robot apparatus 1 includes a system controller 111, an image processing unit 112, a voice processing unit 113, a display control unit 114, a wireless communication unit 115, a map information memory unit 116, a movement control unit 117, a battery 118, a charge terminal 119, and an infrared interface unit 200.

The system controller 111 is a processor for controlling the respective components of the robot apparatus 1. The system controller 111 controls the actions of the robot apparatus 1. The image processing unit 112 processes, under control of the system controller 111, images that are taken by the camera 14. Thereby, the image processing unit 112 executes, for instance, a face detection process that detects and extracts a face image area corresponding to the face of person, from the image that are taken by the camera 14. In addition, the image processing unit 112 executes a process for extracting features of the surrounding environment, on the basis of images that are taken by the camera 14, thereby to produce map information within the house, which is necessary for auto-movement of the robot apparatus 1.

The voice processing unit 113 executes, under control of the system controller 111, a voice (speech) recognition process for recognizing a voice (speech) signal that is input from the microphone (MIC) 16, and a voice (speech) synthesis process for producing a voice (speech) signal that is to be output from the speaker 20. The display control unit 114 is a graphics controller for controlling the LCD 19.

The wireless communication unit 115 executes wireless communication with the outside via the antenna 22. The wireless communication unit 115 comprises a wireless communication module such as a mobile phone or a wireless modem. The wireless communication unit 115 can execute transmission/reception of voice and data with an external terminal such as a mobile phone. The wireless communication unit 115 is used, for example, in order to inform the mobile phone of the user, who is out of the house, of occurrence of abnormality within the house, or in order to send video, which shows conditions of respective locations within the house, to the user's mobile phone.

The map information memory unit 116 is a memory unit that stores map information, which is used for auto-movement of the robot apparatus 1 within the house. The map information is map data relating to the inside of the house. The map information is used as path information that enables the robot apparatus 1 to autonomously move to a plurality of predetermined check points within the house. As is shown in FIG. 3, the user can designate given locations within the house as check points P1 to P6 that require monitoring. The map information can be generated by the robot apparatus 1.

Now let us consider a case where the robot apparatus 1 generates map information that is necessary for patrolling the check points P1 to P6. For example, the user guides the robot apparatus 1 from a starting point to a destination point by a manual operation or a remote operation using an infrared remote-control unit. While the robot apparatus 1 is being guided, the system controller 111 observes and recognizes the surrounding environment using video acquired by the camera 14. Thus, the system controller 111 automatically generates map information on a route from the starting point to the destination point. Examples of the map information include coordinates information indicative of the distance of movement and the direction of movement, and environmental map information that is a series of characteristic images indicative of the surrounding environment.

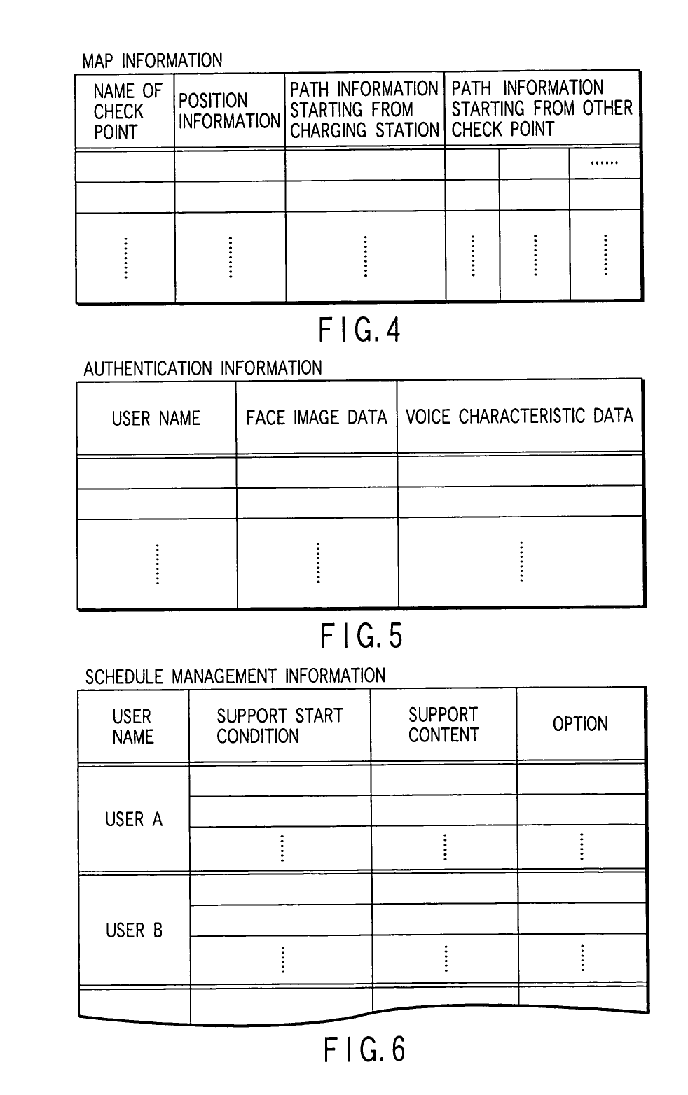

In the above case, the user guides the robot apparatus 1 by manual or remote control in the order of check points P1 to P6, with the start point set at the location of a charging station 100 for battery-charging the robot apparatus 1. Each time the robot apparatus 1 arrives at a check point, the user notifies the robot apparatus 1 of the presence of the check point by operating the buttons 18 or by a remote-control operation. Thus, the robot apparatus 1 is enabled to learn the path of movement (indicated by a broken line) and the locations of check points along the path of movement. It is also possible to make the robot apparatus 1 learn each of individual paths up to the respective check points P1 to P6 from the start point where the charging station 100 is located. While the robot apparatus 1 is being guided, the system controller 111 of robot apparatus 1 successively records, as map information, characteristic images of the surrounding environment that are input from the camera 14, the distance of movement, and the direction of movement. FIG. 4 shows an example of the map information.

The map information in FIG. 4 indicates [NAME OF CHECK POINT], [POSITION INFORMATION], [PATH INFORMATION STARTING FROM CHARGING STATION) and [PATH INFORMATION STARTING FROM OTHER CHECK POINT] with respect to each of check points designated by the user. The [NAME OF CHECK POINT] is a name for identifying the associated check point, and it is input by the user's operation of buttons 18 or the user's voice input operation. The user can freely designate the names of check points. For example, the [NAME OF CHECK POINT] of check point P1 is “kitchen stove of dining kitchen”, and the (NAME OF CHECK POINT] of check point P2 is “window of dining kitchen.”

The [POSITION INFORMATION] is information indicative of the location of the associated check point. This information comprises coordinates information indicative of the location of the associated check point, or a characteristic image that is acquired by imaging the associated check point. The coordinates information is expressed by two-dimensional coordinates (X, Y) having the origin at, e.g. the position of the charging station 100. The [POSITION INFORMATION] is generated by the system controller 111 while the robot apparatus 1 is being guided.

The [PATH INFORMATION STARTING FROM CHARGING STATION] is information indicative of a path from the location, where the charging station 100 is placed, to the associated check point. For example, this information comprises coordinates information that indicates the length of an X-directional component and the length of a Y-directional component with respect to each of straight line segments along the path, or environmental map information from the location, where the charging station 100 is disposed, to the associated check point. The [PATH INFORMATION STARTING FROM CHARGING STATION] is also generated by the system controller 111.

The [PATH INFORMATION STARTING FROM OTHER CHECK POINT] is information indicative of a path to the associated check point from some other check point. For example, this information comprises coordinates information that indicates the length of an X-directional component and the length of a Y-directional component with respect to each of straight line segments along the path, or environmental map information from the location of the other check point to the associated check point. The [PATH INFORMATION STARTING FROM OTHER CHECK POINT] is also generated by the system controller 111.

The movement control unit 117 shown in FIG. 2 executes, under control of the system controller 111, a movement control process for autonomous movement of the robot body 11 to a target position according to the map information. The movement control unit 117 includes a motor that drives the two wheels 13 of the movement mechanism, and a controller for controlling the motor.

The battery 13 is a power supply for supplying operation power to the respective components of the robot apparatus 1. The charging of the battery 13 is automatically executed by electrically connecting the charging terminal 119, which is provided on the robot body 11, to the charging station 100. The charging station 100 is used as a home position of the robot apparatus 1. At an idling time, the robot apparatus 1 autonomously moves to the home position. If the robot apparatus 1 moves to the charging station 100, the charging of the battery 13 automatically starts.

The infrared interface unit 200 is used, for example, to remote-control the turn on/off of devices, such as an air conditioner, a kitchen stove and lighting equipment, by means of infrared signals, or to receive infrared signals from the external remote-control unit.

The system controller 111, as shown in FIG. 2, includes a face authentication process unit 201, a security function control unit 202 and a schedule management unit 203. The face authentication process unit 201 cooperates with the image processing unit 112 to analyze a person's face image that is taken by the camera 14, thereby executing an authentication process for identifying the person who is imaged by the camera 14.

In the authentication process, face images of users (family members), which are prestored in the authentication information memory unit 211 as authentication information, are used. The face authentication process unit 201 compares the face image of the person imaged by the camera 14 with each of the face images stored in the authentication information memory unit 211. Thereby, the face authentication process unit 201 can determine which of the users corresponds to the person imaged by the camera 14, or whether the person imaged by the camera 14 is a family member or not. FIG. 5 shows an example of authentication information that is stored in the authentication information memory unit 211. As is shown in FIG. 5, the authentication information includes, with respect to each of the users, the user name, the user face image data and the user voice characteristic data. The voice characteristic data is used as information for assisting user authentication. Using the voice characteristic data, the system controller 111 can determine which of the users corresponds to the person who utters voice, or whether the person who utters voice is a family member or not.

The security function control unit 202 controls the various sensors (sensors 21, camera 14, microphone 16) and the movement mechanism 13, thereby executing a monitoring operation for detecting occurrence of abnormality within the house (e.g. entrance of a suspicious person, fire, failure to turn out the kitchen stove, leak of gas, failure to turn off the air conditioner, failure to close the window, and abnormal sound). In other words, the security function control unit 202 is a control unit for controlling the monitoring operation (security management operation) for security management, which is executed by the robot apparatus 1.

The security function control unit 202 has a plurality of operation modes for controlling the monitoring operation that is executed by the robot apparatus 1. Specifically, the operation modes include an “at-home mode” and a “not-at-home mode.”

The “at-home mode” is an operation mode that is suited to a dynamic environment in which a user is at home. The “not-at-home mode” is an operation mode that is suited to a static environment in which users are absent. The security function control unit 202 controls the operation of the robot apparatus 1 so that the robot apparatus 1 may execute different monitoring operations between the case where the operation mode of the robot apparatus 1 is set in the “at-home mode” and the case where the operation mode of the robot apparatus 1 is set in the “not-at-home mode.” The alarm level (also known as “security level”) of the monitoring operation, which is executed in the “not-at-home mode”, is higher than that of the monitoring operation, which is executed in the “at-home mode.”

For example, in the “not-at-home mode,” if the face authentication process unit 201 detects that a person other than the family members is present within the house, the security function control unit 202 determines that a suspicious person has entered the house, and causes the robot apparatus 1 to immediately execute an alarm process. In the alarm process, the robot apparatus 1 executes a process of sending, by e-mail, etc., a message indicative of the entrance of the suspicious person to the user's mobile phone, a security company, etc. On the other hand, in the “at-home mode”, the execution of the alarm process is prohibited. Thereby, even if the face authentication process unit 201 detects that a person other than the family members is present within the house, the security function control unit 202 only records an image of the face of the person and does not execute the alarm process. The reason is that in the “at-home mode” there is a case where a guest is present in the house.

Besides, in the “not-at-home mode”, if the sensors detect abnormal sound, abnormal heat, etc., the security function control unit 202 immediately executes the alarm process. In the “at-home mode”, even if the sensors detect abnormal sound, abnormal heat, etc., the security function control unit 202 does not execute the alarm process, because some sound or heat may be produced by actions in the user's everyday life. Instead, the security function control unit 202 executes only a process of informing the user of the occurrence of abnormality by issuing a voice message such as “abnormal sound is sensed” or “abnormal heat is sensed.”

Furthermore, in the “not-at-home mode”, the security function control unit 202 cooperates with the movement control unit 117 to control the auto-movement operation of the robot apparatus 1 so that the robot apparatus 1 may execute an auto-monitoring operation. In the auto-monitoring operation, the robot apparatus 1 periodically patrols the check points P1 to P5. In the “at-home mode”, the robot apparatus 1 does not execute the auto-monitoring operation that involves periodic patrolling.

The security function control unit 202 has a function for switching the operation mode between the “at-home mode” and “not-at-home mode” in response to the user's operation of the operation buttons 21. In addition, the security function control unit 202 may cooperate with the voice processing unit 113 to recognize, e.g. a voice message, such as “I'm on my way” or “I'm back”, which is input by the user. In accordance with the voice input from the user, the security function control unit 202 may automatically switch the operation mode between the “at-home mode” and “not-at-home mode.”

The schedule management unit 203 manages the schedules of a plurality of users (family members) and thus executes a schedule management process for supporting the actions of each user. The schedule management process is carried out according to schedule management information that is stored in a schedule management information memory unit 212. The schedule management information is information for individually managing the schedule of each of the users. In the stored schedule management information, user identification information is associated with an action that is to be done by the user who is designated by the user identification information and with the condition for start of the action.

The schedule management information, as shown in FIG. 6, includes a [USER NAME] field, a [SUPPORT START CONDITION] field, a [SUPPORT CONTENT] field and an [OPTION] field. The [USER NAME] field is a field for storing the name of the user as user identification information.

The [SUPPORT START CONDITION] field is a field for storing information indicative of the condition on which the user designated by the user name stored in the [USER NAME] field should start the action. For example, the [SUPPORT START CONDITION] field stores, as a start condition, a time (date, day of week, hour, minute) at which the user should start the action, or the content of an event (e.g. “the user has had a meal,” or “it rains”) that triggers the start of the user's action. Upon arrival of the time set in the [SUPPORT START CONDITION] field or in response to the occurrence of an event set in the [SUPPORT START CONDITION] field, the schedule management unit 203 controls the operation of the robot apparatus 1 so that the robot apparatus 1 may start a supporting action that supports the user's action.

The [SUPPORT CONTENT] field is a field for storing information indicative of the action that is to be done by the user. For instance, the [SUPPORT CONTENT] field stores the user's action such as “going out”, “getting up”, “taking a drug”, or “taking the washing in.” The schedule management unit 203 controls the operation of the robot apparatus 1 so that the robot apparatus 1 may execute a supporting action that corresponds to the content of user's action set in the [SUPPORT CONTENT] field. Examples of the supporting actions that are executed by the robot apparatus 1 are: “to prompt going out”, “to read with voice the check items (closing of windows/doors, turn-out of gas, turn-off of electricity) for safety confirmation at the time of going out”, “to read with voice the items to be carried at the time of going out”, “to prompt getting up”, “to prompt taking drugs”, and “to prompt taking the washing in.” The [OPTION] field is a field for storing, for instance, information on a list of check items for safety confirmation as information for assisting a supporting action.

As mentioned above, the action to be done by the user is stored in association with the condition for start of the action and the user identification information. Thus, the system controller 111 can execute the support process for supporting the scheduled actions of the plural users.

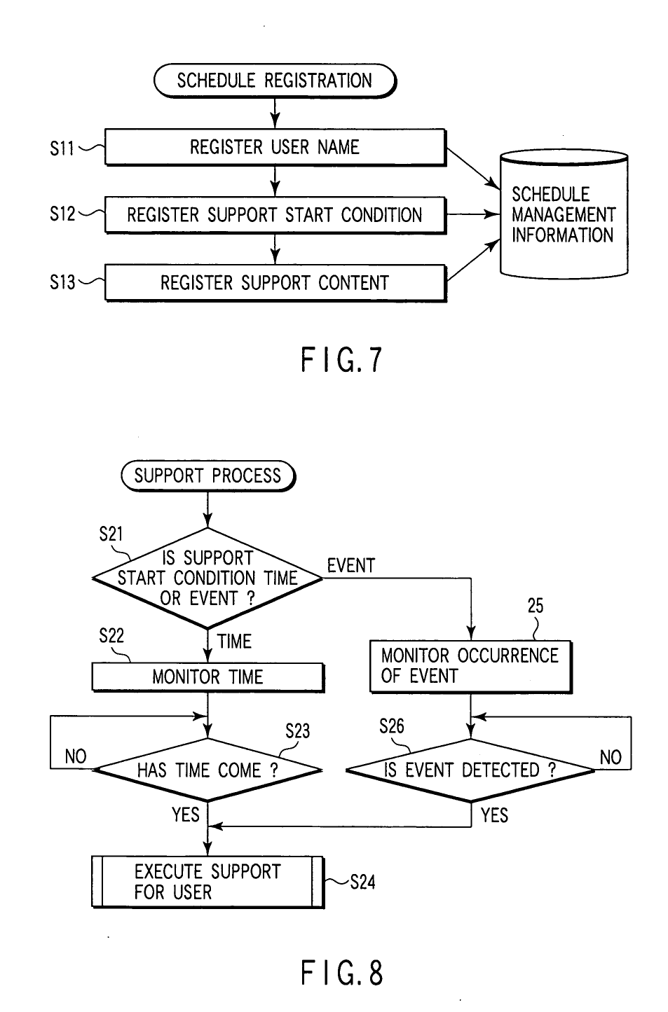

The schedule management information is registered in the schedule management information memory unit 212 according to the procedure illustrated in a flow chart of FIG. 7. The schedule management information may be registered by voice input.

To start with, the user sets the robot apparatus 1 in a schedule registration mode by operating the operation buttons 18 or by voice input. Then, if the user says “take a drug after each meal”, the schedule management unit 203 registers in the [USER NAME] field the user name corresponding to the user who is identified by the face authentication process (step S11). In addition, the schedule management unit 203 registers “having a meal” in the [SUPPORT START CONDITION] field and registers “taking a drug” in the [SUPPORT CONTENT] field (steps S12 and S13). Thus, the schedule management information is registered in the schedule management information memory unit 212.

The user may register the schedule management information by a pen input operation, etc. The information relating to the action to be done by the user (e.g. “going out”, “getting up”, “taking a drug”, or “taking the washing in”) may not be registered in the [SUPPORT CONTENT] field. Instead, the [SUPPORT CONTENT] field may register the content of the supporting action that is to be executed by the robot apparatus 1 in order to support the user's action (e.g. “to prompt going out”, “to read with voice the check items for safety confirmation at the time of going out”, “to read with voice the items to be carried at the time of going out”, “to prompt getting up”, “to prompt taking a drug”, and “to prompt taking the washing in”).

Next, referring to a flow chart of FIG. 8, an example of the procedure of the schedule management process that is executed by the robot apparatus 1 is described.

The system controller 111 executes the following process for each item of schedule management information that is stored in the schedule management information memory unit 212.

The system controller 111 determines whether the start condition stored in the [SUPPORT START CONDITION] field is “time” or “event” (step S21). If the start condition is “time”, the system controller 111 executes a time monitoring process for monitoring the arrival of a time designated in the [SUPPORT START CONDITION] field (step S22). If the time that is designated in the [SUPPORT START CONDITION] field has come, that is, if the start condition that is designated in the [SUPPORT START CONDITION] field is established (YES in step S23), the system controller 111 executes a support process for supporting the user's action, which is stored in the [SUPPORT CONTENT] field corresponding to the established start condition, with respect to the user who is designated by the user name stored in the [USER NAME] field corresponding to the established start condition (step S24).

If the start condition is “event”, the system controller 111 executes an event monitoring process for monitoring occurrence of an event that is designated in the [SUPPORT START CONDITION] field (step S25). The event monitoring process is executed using the movement mechanism 13 and various sensors (camera 14, microphone 16, sensors 21).

In this case, if the event designated in the [SUPPORT START CONDITION] field is an event relating to the user's action, such as “having a meal”, the system controller 111 finds, by a face authentication process, the user designated by the user name that is stored in the [USER NAME] field corresponding to the event. Then, the system controller 111 controls the movement mechanism 13 to move the robot body 11 to the vicinity of the user. While controlling the movement mechanism 13 so as to cause the robot body 11 to move following the user, the system controller 111 monitors the action of the user by making use of, e.g. video of the user acquired by the camera 14.

When the event designated in the [SUPPORT START CONDITION] field occurs, that is, when the start condition designated in the [SUPPORT START CONDITION] field is established (YES in step S26), the system controller 111 executes a support process for supporting the user's action, which is stored in the [SUPPORT CONTENT] field corresponding to the established start condition, with respect to the user who is designated by the user name stored in the [USER NAME] field corresponding to the established start condition (step S24).

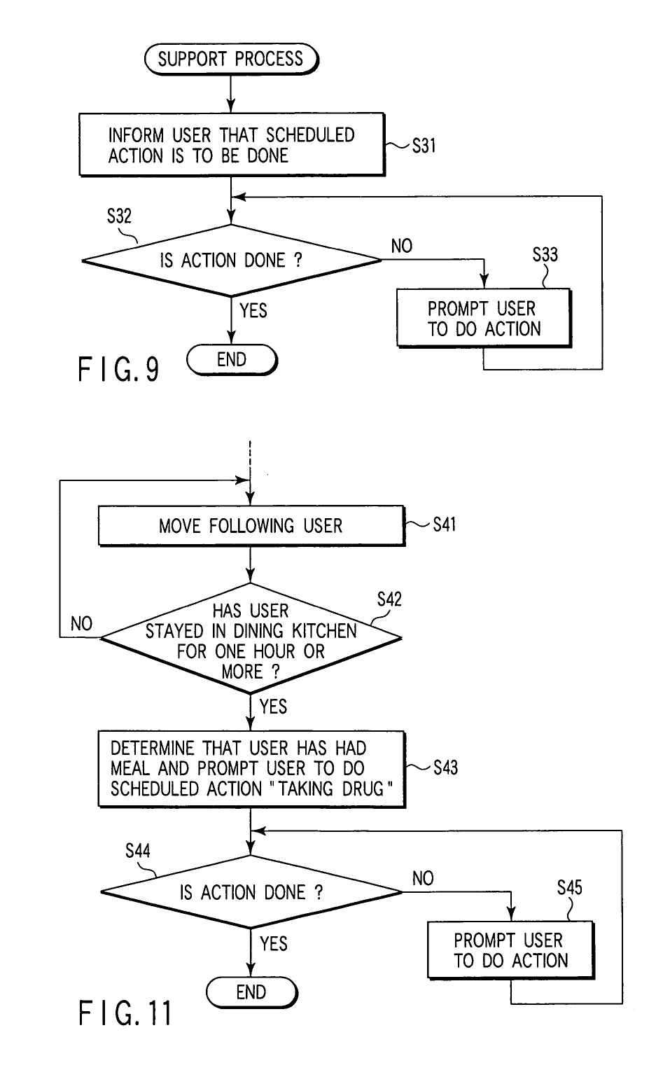

A flow chart of FIG. 9 illustrates an example of the procedure that is executed in the support process in step S24 in FIG. 8.

The system controller 111 informs the user of the content of the action stored in the [SUPPORT CONTENT] field and prompts the user to do the action (step S31). In step S31, if the user's scheduled action stored in the [SUPPORT CONTENT] field is “going out”, the system controller 111 executes a process for producing from the speaker 20 a voice message “It's about time to go out.” If the user's scheduled action stored in the [SUPPORT CONTENT] field is “taking a drug”, the system controller 111 executes a process for producing a voice message “Have you taken a drug?” from the speaker 20.

In order to make it clear which user is prompted to do the action, it is preferable to produce a voice message associated with the user name that is stored in the [USER NAME] field corresponding to the established start condition. In this case, the system controller 111 acquires the user name “XXXXXX” that is stored in the [USER NAME] field corresponding to the established start condition, and executes a process for producing a voice message, such as “Mr./Ms. XXXXXX, it's about time to go out.” or “Mr./Ms. XXXXXX, have you taken a drug?”, from the speaker 20.

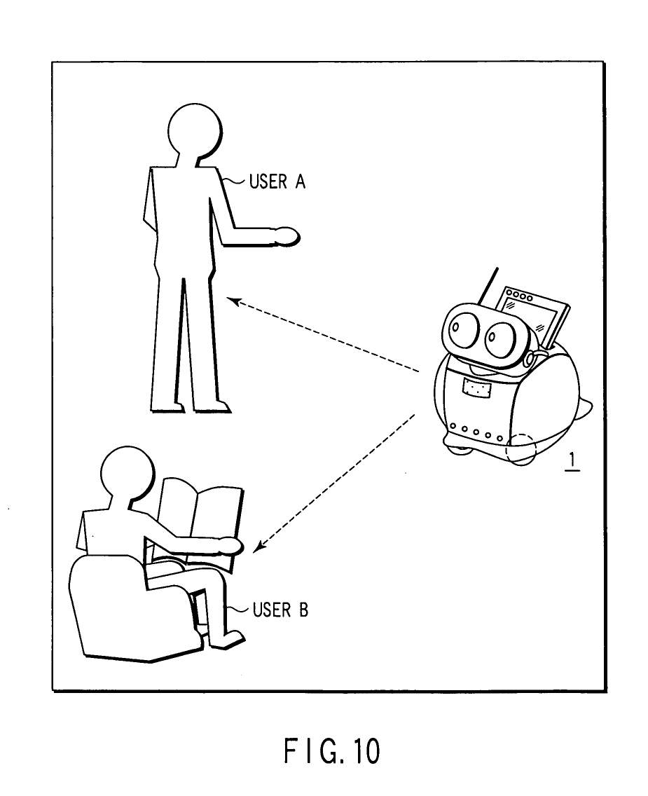

Instead of reading the user name aloud, or additionally, it is possible to identify the user by a face recognition process, approach the user, and produce a voice message, such as “It's about time to go out.” or “Have you taken a drug?”, from the speaker 20. FIG. 10 illustrates this operation. FIG. 10 shows that a user A and a user B are present in the same room. The system controller 111 of the robot apparatus 1 discriminates, by a face recognition process, which of the user A and user B corresponds to the user who is designated by the user name corresponding to the established start condition. If the user who is designated by the user name corresponding to the established start condition is the user A, the system controller 111 controls the movement mechanism 13 so that the robot apparatus 1 may move close to the user A. If the user who is designated by the user name corresponding to the established start condition is the user B, the system controller 111 controls the movement mechanism 13 so that the robot apparatus 1 may move close to the user B.

After prompting the user to do the scheduled action, the system controller 111 continues to monitor the user's action using video input from the camera 14 or voice input from the microphone 16 (step S32). For example, in the case where the user's scheduled action is “going out”, the system controller 111 determines that the user has gone out, if it recognizes the user's voice “I'm on my way.” In addition, the system controller 111 may determine whether the user's action is completed or not, by executing a gesture recognition process for recognizing the user's specified gesture on the basis of video input from the camera 14.

If the scheduled action is not done within a predetermined time period (e.g. 5 minutes) (NO in step S32), the system controller 111 prompts the user once again to do the scheduled action (step S33).

Next, referring to a flow chart of FIG. 11, a description is given of an example of the schedule management process corresponding to the user's scheduled action “taking a drug after each meal.”

If a scheduled time of a meal draws near, the system controller 111 identifies, by a face authentication process, the user whose scheduled action is “taking a drug after each meal”. The system controller 111 controls the movement mechanism 13 of robot apparatus 1 so that the robot apparatus 1 may move following the user (step S41). In the control of movement, a video image of the back of each user, which is stored in the robot apparatus 1, is used. The system controller 111 controls the movement of the robot apparatus 1, while comparing a video image of the back of the user, which is input from the camera, with the video image of the back of the user, which is stored in the robot apparatus 1.

If the system controller 111 detects that the user, whose scheduled action “taking a drug after each meal” is registered, stays for a predetermined time period or more at a preset location in the house, e.g. in the dining kitchen (YES in step S42), the system controller 111 determines that the user finishes the meal and produces a voice message, such as “Mr./Ms. XXXXXX, have you taken a drug?” or “Mr./Ms. XXXXXX, please take a drug”, thus prompting the user to do the user's scheduled action “taking a drug after each meal” (step S44).

Thereafter, the system controller 111 determines whether the user has done the action of taking a drug, for example, by a gesture recognition process (step S44). If the scheduled action is not executed even after a predetermined time or more (e.g. 5 minutes) has passed (NO in step S44), the system controller 111 prompts the user once again to do the scheduled action (step S45).

As has been described above, the robot apparatus 1 of this embodiment can support scheduled actions of a plurality of users in the house. In particular, the robot apparatus 1 can support actions that are to be done by the user, with respect to not only a schedule that is managed based on time but also a schedule that is executed in accordance with occurrence of an event.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A robot apparatus comprising:
a memory unit that stores schedule information indicative of a user identifier for designating one of a plurality of users, an action that is to be done by the user designated by the user identifier, and a start condition for the action;
a determination unit that determines whether a condition designated by the start condition is established; and
a support process execution unit that executes, when the condition designated by the start condition is established, a support process, based on the schedule information, for supporting the user's action corresponding to the established start condition with respect to the user designated by the user identifier corresponding to the established start condition.

2. The robot apparatus according to claim 1, wherein the user identifier includes a user name of the user who is designated by the user identifier, and
the support process execution unit includes a voice output unit that produces a voice message corresponding to the user name, which is included in the user identifier corresponding to the established start condition, and a voice message that prompts the user to do the action corresponding to the established start condition.

3. The robot apparatus according to claim 1, wherein the support process execution unit includes a unit which identifies the user designated by the user identifier corresponding to the established start condition by recognizing the face of a person present in a house, and a voice output unit that produces a voice message, which prompts the identified user to execute the action corresponding to the established start condition.

4. The robot apparatus according to claim 1, wherein the schedule information includes information indicative of an event, other than time, as the start condition, and
the determination unit includes a unit that executes a monitor operation for detecting occurrence of said event other than time.

5. The robot apparatus according to claim 1, wherein the schedule information includes, as the start condition, information indicative of an event relating to the action of the user designated by the user identifier, and
the determination unit includes a unit that identifies the user designated by the user identifier by recognizing the face of a person present in a house, and a unit that monitors the action of the identified user, thereby to detect occurrence of the event.

6. A robot apparatus comprising:
a body having an auto-movement mechanism;
a sensor that is provided on the body and senses a surrounding condition;
a memory unit that stores schedule information indicative of a user identifier for designating one of a plurality of users, an action that is to be done by the user designated by the user identifier, and an event that is a start condition for the action;
a monitor unit that executes a monitor operation for detecting occurrence of the event, using the auto-movement mechanism and the sensor; and
a support process execution unit that executes, when the occurrence of the event is detected by the monitor unit, a support process, based on the schedule information, for supporting the user's action corresponding to the event whose occurrence is detected, with respect to the user designated by the user identifier corresponding to the event whose occurrence is detected.

7. The robot apparatus according to claim 6, wherein the support process execution unit includes a unit which identifies the user designated by the user identifier corresponding to the event whose occurrence is detected, by recognizing the face of a person present in a house, and a voice generation unit that produces a voice message, which prompts the identified user to execute the action corresponding to the event whose occurrence is detected.

8. The robot apparatus according to claim 6, wherein the user identifier includes a user name of the user who is designated by the user identifier, and
the support process execution unit includes a voice output unit that produces a voice message corresponding to the user name, which is included in the user identifier corresponding to the event whose occurrence is detected, and a voice message that prompts the user to do the action corresponding to the event whose occurrence is detected.

9. A robot apparatus comprising:
means for storing schedule information indicative of a user identifier for designating one of a plurality of users, an action that is to be done by the user designated by the user identifier, and a start condition for the action;
means for determining whether a condition designated by the start condition is established; and
means for executing, when the condition designated by the start condition is established, a support process, based on the schedule information, for supporting the user's action corresponding to the established start condition with respect to the user designated by the user identifier corresponding to the established start condition.

10. The robot apparatus according to claim 9, wherein the user identifier includes a user name of the user who is designated by the user identifier, and
the means for executing the support process includes means for producing a voice message corresponding to the user name, which is included in the user identifier corresponding to the established start condition, and means for prompting the user to do the action corresponding to the established start condition.

11. The robot apparatus according to claim 9, wherein the means for executing the support process includes means for identifying the user designated by the user identifier corresponding to the established start condition by recognizing the face of a person present in a house, and means for producing a voice message, which prompts the identified user to execute the action corresponding to the established start condition.

12. The robot apparatus according to claim 9, wherein the schedule information includes information indicative of an event, other than time, as the start condition, and
the means for determining includes means for executing a monitor operation for detecting occurrence of said event other than time.

13. The robot apparatus according to claim 9, wherein the schedule information includes, as the start condition, information indicative of an event relating to the action of the user designated by the user identifier, and
the means for determining includes means for identifying the user designated by the user identifier by recognizing the face of a person present in a house, and means for monitoring the action of the identified user, thereby to detect occurrence of the event.
